(19) United States
(12) Patent Application Publication
(10) Pub. No.: US 2006/0093289 A1
(43) Pub. Date: May 4, 2006

(54) ELECTRO-OPTICAL SUBASSEMBLY

(75) Inventors: Adrianus J. P. Van Haasteren, Singapore (SG); Alvin Tze Yen Lim, Singapore (SG); Frank Flens, Singapore (SG); Tom Sheau Tung Wong, Singapore (SG)

Correspondence Address: AVAGO TECHNOLOGIES, LTD., P.O. BOX 1920, DENVER, CO, 80201-1920, US

(73) Assignee: AGILENT TECHNOLOGIES, INC., Loveland, CO (US)

(21) Appl. No.: 10/904,224

(22) Filed: Oct. 29, 2004

(51) Int. Cl. G02B 6/36

(52) U.S. Cl. 385/93

(57) ABSTRACT

An electro-optical subassembly formed using an optical unit and a base. The optical unit has a lens and a cavity in communication with the lens, the cavity having surfaces aligned with the lens. The base includes a body, shaped to fit within the cavity so as to have a predetermined alignment with the lens, and a plurality of leads embedded in and extending from the body. At least one end of one lead is positioned behind the lens when the base is inserted into the cavity. An electro-optical component supported by the at least one lead behind the lens and is optically accessible to the lens when the base is inserted into the optical unit.

### BACKGROUND OF THE INVENTION

Electro-Optical (EO) components, like lasers and PIN (positive-intrinsic-negative) monitors, used in transmitters and receivers in fiber communication, are usually packaged utilizing the transistor outline construction (sometimes referred to as a “TO can”). The EO components inside a TO can are wire-bonded to a number of leads that protrude through the package and allow signals to be routed to the EO components. These leads are bent and soldered onto a PCB board that contains the electronic components and circuitry to drive the EO components.

A TO can has several disadvantages. The leads, typically a few millimeters in length, cause a degradation of the frequency response of the subassembly. The leads also have to be bent and soldered onto the PCB board. This process is difficult to automate and is typically performed by hand. Yet another disadvantage is the mechanical tolerances stack up, e.g. the tolerance for the lens placement is affected by die placement. This requires that each component be positioned using a dedicated three-alignment system: one for die placement; one for lens placement; and one for the receptacle.

The present inventors have recognized a need for an electro-optical subassembly that eliminates some of the disadvantages of the TO can style subassembly.

### BRIEF DESCRIPTION OF THE DRAWINGS

An understanding of the present invention can be gained from the following detailed description of the invention, taken in conjunction with the accompanying drawings of which:

FIG. 1 is an isometric view of an electro-optical subassembly in accordance with an embodiment of the present invention.

FIG. 2 is a plan view of a lead frame in accordance with an embodiment of the present invention.

FIG. 3a is a plan view of a partial lead frame in accordance with an embodiment of the present invention.

FIG. 3b is a plan view of a partial lead frame in accordance with an embodiment of the present invention.

FIG. 4 is a three-dimensional plan view of a partial lead frame with molded features in accordance with an embodiment of the present invention.

FIG. 5 is an isometric view of a partial lead frame with molded features in accordance with an embodiment of the present invention.

FIG. 6 is an isometric view of an optical unit in accordance with an embodiment of the present invention.

FIG. 7a is a plan view of a optical unit in accordance with an embodiment of the present invention.

FIG. 7b is a sectional side view of a optical unit in accordance with an embodiment of the present invention.

FIG. 7c is a sectional side view of a optical unit in accordance with an embodiment of the present invention.

### DETAIL DESCRIPTION

Reference will now be made in detail to the present invention, examples of which are illustrated in the accompanying drawings, wherein like reference numerals refer to like elements throughout. In the description contained hereinafter, the use of a lowercase “n” adjacent to an element identifier denotes a non-specific instance of the element rather than a specific instance identified using a non-italicized letter adjacent to the element number or the general collection of all instances discussed using the element number by itself with a letter modifier.

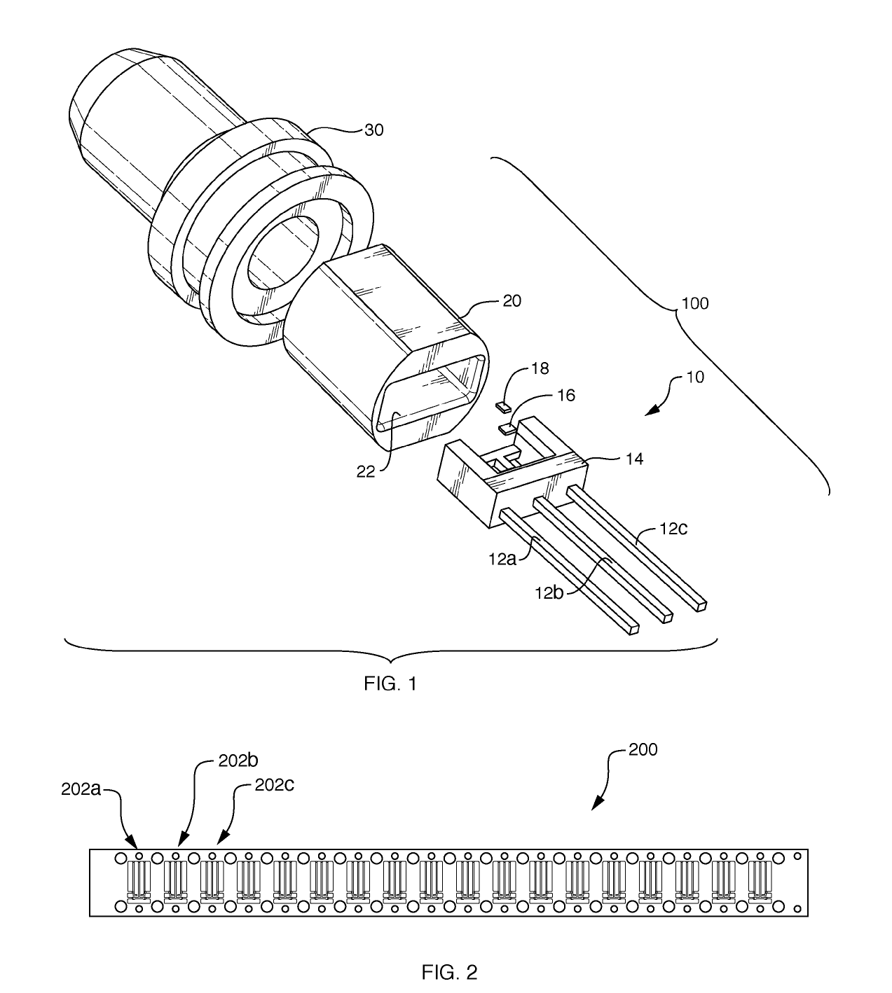

FIG. 1 is an isometric view of an electro-optical subassembly 100 in accordance with an embodiment of the present invention. The electro-optical assemble 100 generally comprises a base 10 and an optical unit 20. The base 10 generally comprises a collection of leads 12 partially encased by a molded body 14. Electro-optical components, such as a PIN detector 16 and a laser 18 and, are fixed to one or more leads 12n. The optical unit 20 has a cavity 22 that accepts the base 10 and facilitates alignment of electro-optical components (such as 16 and 18) with an optical lens (not shown). The optical lens may formed as part of the optical unit 20 or seated in place. The electro-optical subassembly 100 mates with a port 30 that facilitates alignment of the optical unit 20 with an optical cable (not shown).

The electro-optical assembly 100 provides many advantageous. The base 10 can be manufactured using common techniques. The leads 12 can be formed using standard technologies and, if desired, can be configured to facilitate surface mounting the electro-optical subassembly 100 onto a PCB board (not shown). The design of the base 10 allows the overall size of the electro-optical subassembly 100 to be reduced as compared to a TO-can. This size reduction minimizes disruptive thermal expansions and reduces the distance between the electro-optical components and the optical lens. Further, as the leads 12 are anchored into the modeled body 14, overall rigidity is increased. Since the optical lens and the laser 18 are referenced against the same base, XY-alignment of the lens may be redundant. The emitting surface of the laser 18 can be accurately positioned relative to the optical lens making Z-alignment of the port 30 redundant, reducing the typical three-alignment process to a two-alignment process.

FIG. 2 is a plan view of a lead frame 200 in accordance with an embodiment of the present invention. The etched lead frame 200 generally comprises a rectangular copper sheet stamped to form a plurality of lead sets 202.

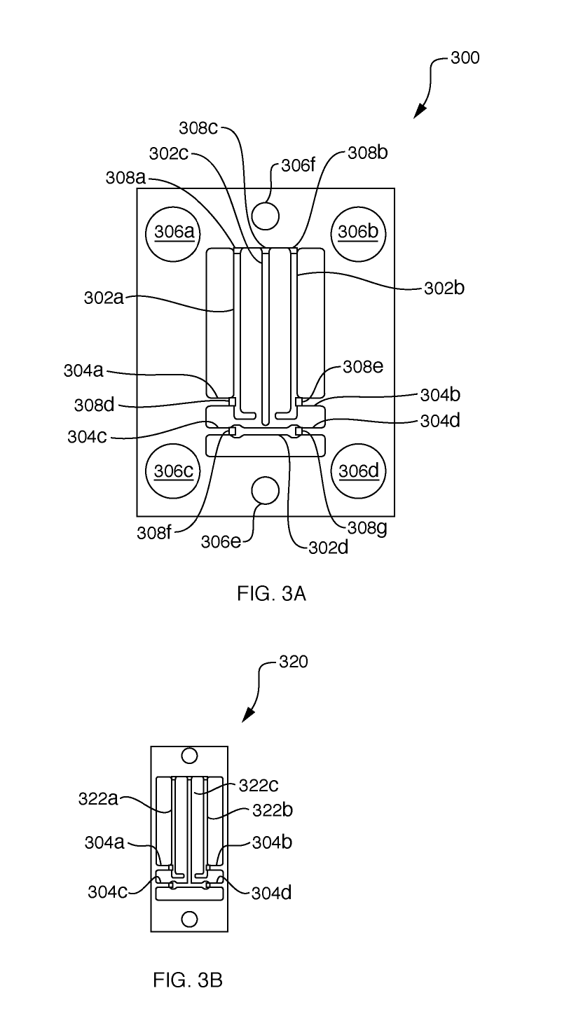

FIG. 3a is a plan view of a partial lead frame in accordance with an embodiment of the present invention. More specifically, FIG. 3a illustrates a single lead set 300 from the lead frame 200 illustrated in FIG. 2. The lead set 300 may be etched or stamped from a strip of conductive material such as copper or gold. The lead set 300 generally comprises four leads including two opposing “L” shaped leads 302a and 302b; a straight lead 302c extending between the opposing “L” shaped leads 302a and 302b; and a second straight lead 302d spaced from and perpendicular to the straight lead 302c. For added support during fabrication, detachable tie bars 304n are formed. In the example shown in FIG. 3a: tie bar 304a supports lead 302a; tie bar 304b supports lead 302b; and tie bars 304c and 304d support lead 302d. After the body 14 is molded onto the leads 302n, the base 10 will be removed from the frame 300 at features 308. Features 308 are essentially weakened portions of the frame permitting the body 14 and leads 302 to be snapped out. A series of holes 306n are formed in the frame 200 to facilitate alignment and automation of the fabrication process.

It may prove beneficial to provide one lead to hold an edge emitting laser (such as the laser 18); one lead to hold a detector (such as the PIN monitor 16); and one or two leads for Vcc or signal ground. The monitor PIN 16 preferable sits behind and somewhat below the laser. If the lead frame 300 is stamped, the central lead 302c may be formed lower relative to lead 302d. If the lead frame 300 is etched, the lowering of the central lead 302c may be done by post process. The center lead 302c is generally Vcc to provide power to the PIN 16. PINs generally need a separate lead for ground that, looking at the example in FIG. 3a may be either of the L-shaped leads 302a and 302b. The PIN 16 may be wirebonded to which ever of the leads is designated as ground.

The P pad location on FP lasers may be either on top or the bottom. The lead configuration may be adjusted to cater to each configuration. Looking at FIG. 3A, the laser 18 sits on a isolated cross bar 302d. Depending on the configuration of the laser 18, a wirebond from the center lead 302c may either be connected to a top pad on the laser 18 to the cross bar 302d on which the laser sits. This configuration may provide an advantage in that the laser 18 is somewhat thermally isolated from the printed circuit board assembly on which electro-optical subassembly 100 sits.

To provide some context regarding the dimensional benefits possible with the present invention, a set of example dimensions will be provided. In no way is the recitation of these dimensions indented to limit the scope of the claimed invention to the stated sizes. By way of example, the overall dimension of the cut out section forming the lead frames 202n is 6.35 mm wide and 12 mm tall. It is to be noted that 12 mm may be too long for commercial applications where shorter leads may be desirable. The leads 302n are approximately 0.35 mm wide with a 1.150 gap between the vertical portions of the leads. The lead spacing of 1.15 mm drives the overall width of 6.35 mm. The limits of the spacing will vary depending on the capability of the stamping or etching house. By way of example, a spacing of 0.5 mm may be preferable for speed. A gap of 0.33 mm may be provided between the extensions of the “L” shaped leads and the central straight lead 302c. Similarly, a gap of 0.2 mm may be provided between the bottom of the central straight lead 302c and the horizontal straight lead 302d.

FIG. 3b is a plan view of a partial lead frame 320 in accordance with an embodiment of the present invention. More specifically, FIG. 3b illustrates a single lead set having a difference configuration of leads 322 than shown in FIG. 3a. The lead frame 320 has three leads: an “L” lead 322a; an opposing “L” shaped lead 322b; and an inverted “T” shaped lead 322c extending between the opposing “L” shaped leads 322a and 322b. Thus, instead of having two separate perpendicular straight leads, a single inverted “T” shape lead is used. The configuration in FIG. 3b is suitable for lasers having a Vcc pad on the bottom of the die. Basically, this configuration is formed by connecting the leads 302c and 302d (shown in FIG. 3a). In this configuration, the T-shaped lead 322c is the Vcc (center) lead for both the laser 18 and the PIN 16 thereby saving one wirebond. This configuration also provides an efficient thermal path, albeit not as well isolated from the PCB upon which the unit is mounted.

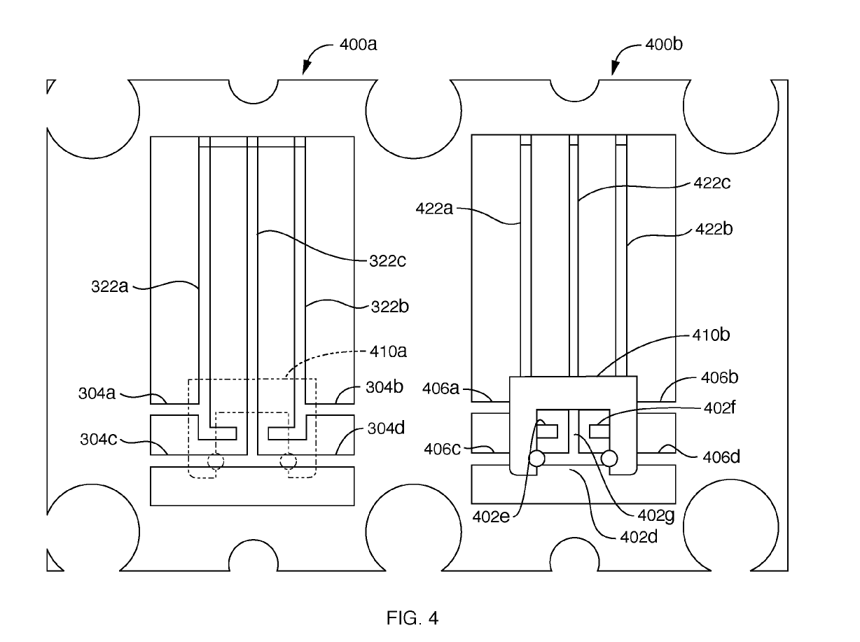

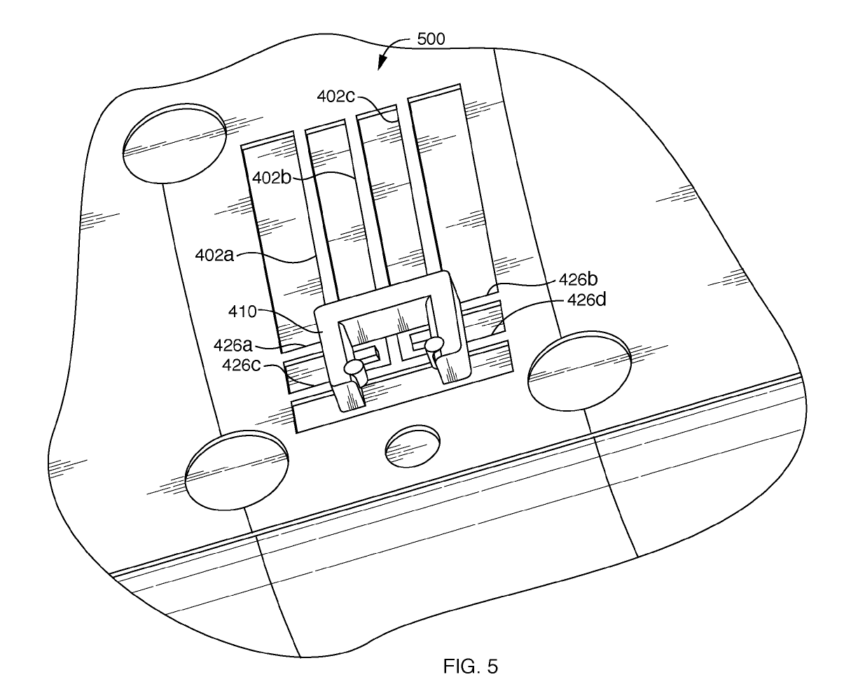

FIG. 4 is a three-dimensional plan view of a partial lead frame with molded features in accordance with an embodiment of the present invention. FIG. 5 is an isometric view of a partial lead frame with molded features in accordance with an embodiment of the present invention. FIG. 4 illustrates two lead frames 400a and 400b having bodies 410a and 410b molded thereon. In the example shown in 400a, the body 410a is rendered transparent to provide a more complete understanding of the invention. The bodies 410a and 410b may be formed of plastic or any other material capable of being molded around the leads while exhibiting low thermal expansion characteristics.

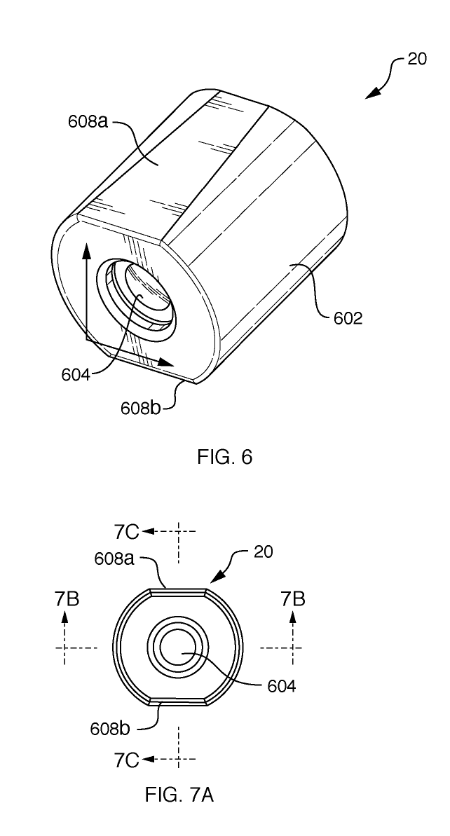

The lead frames 410a and 410b generally have the configuration illustrated in FIG. 3b. The bodies 410a and 410b are roughly “U” shaped with the arms of the U encompassing the ends of the leads 322a through 322c. The open end of the bodies 410a and 410b coincides with the short horizontal portion of the “T” shaped lead 322c. It is through this open end that light may be emitted onto or received from the lens of the optical unit 20. The cross sectional shape of the bodies 410a and 410b coincides with the cross-sectional shape of the cavity 22 so as to fit snuggly within the cavity 22. It may prove beneficial to angle outside edges of the bodies 410n to ease insertion and enable a press fit. The cavity 22 would be similarly angled from the opening to the opposite end near the lens 604 (see FIG. 6). Thus, the cross-sectional dimensions of the end of the arms would be less than the cross-sectional dimensions of the opening of the cavity 22 but equal to or greater than the cross-sectional dimensions of the cavity at a point closer to the lens 604.

The outside surfaces of the body 410n will mate with the surfaces of the cavity 22. Accordingly, by controlling the position of the leads with respect to the outside edges of the bodies 410n, the emitting surface of the laser 18 can be accurately positioned when the electro-optical subassembly 100 is assembled. Using known manufacturing techniques, the bodies 410n may be accurately positioned with respect to the ends of the leads, for example using the holes 306n as an index for positioning the frame within the mold used to create the bodies 410.

FIG. 6 is an isometric view of an optical unit 20 in accordance with an embodiment of the present invention. The optical unit 20 generally comprises a body portion 602 and a lens 604. The body portion 602 generally comprises a frustum having two opposing flat surfaces 608a and 608b. The opposing flat surfaces 608a and 608b may be molded or ground into the body and may serve as alignment features. The lens 604 may comprise an aspherical lens. The exact configuration of the lens 604 will be determined by the required function, for example coupling the light from a laser with an optical fiber and/or coupling the light from an optical fiber to a PIN detector. The lens 604 may be molded with the body 602 and then provided with a clear optical surface. Alternatively, the lens 604 may be turned after the body 602 has been molded.

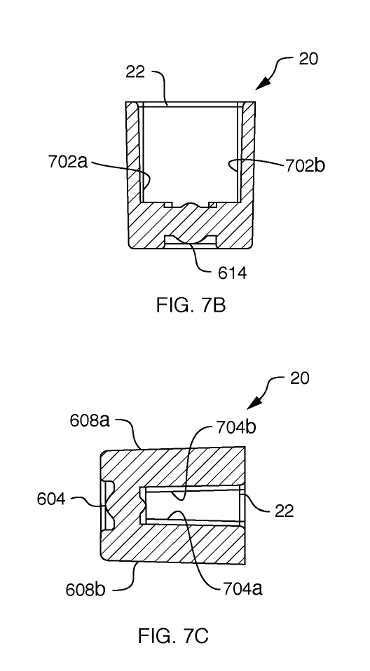

FIGS. 7a through 7c are views of an optical unit 20 in accordance with an embodiment of the present invention. The size of the optical unit 20 may vary, however to provide some context regarding the dimensional benefits possible with the present invention, a set of example dimensions will be provided. The recitation of these dimensions is not intended to limit the scope of the claimed invention to the stated sizes. The body 602 is generally cylindrical with a length of 5.5 mm. The body 602 has a diameter of 4.7 mm at the end in which the lens 604 is formed. The external surface may slope from the longitudinal axis of the optical unit 20, for example 1.5 degrees, to facilitate insertion into the port 30. Any suitable angle from parallel (0 degrees) upward may be formed; however, a slight angle of less than 10 degrees (such as 1.5 degrees) may be preferable. Opposing flat portions 608a and 608b may be formed on the exterior surface for alignment with the port 30. The opposing flat portions 608a and 608b are 4.2 mm apart at the end in which the lens 604 is formed. The lens 604, as illustrated in the example, has an internal aperture of 0.8 mm and an external aperture of 1.378 mm. The lens 604 is 1.5 mm thick. The recess into which the lens 604 is formed has a diameter of 1.925 mm. The cavity 22, as illustrated in the example, is roughly 1.4 mm high, 4 mm wide, and 3.799 mm deep. The walls of the cavity may be sloped to facilitate insertion and alignment of the base 10 and should match the external dimensions of the base 10. Specifically, opposing flat surfaces 702a-702b and 704a-704b may be angled from the optical axis of the lens 604, for example 1 degree. Any suitable angle from parallel (0 degrees) upward may be formed; however, a slight angle of less than 10 degrees may be preferable.

In general, the shape of the cavity 22 and the body 14 should be configured to present an end or edge of one or more leads (for example the leads 308c and 308d in FIG. 3a and the lead 322c in FIG. 3b) in a known relationship to the lens 604 of the optical unit 20.

Although several embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An electro-optical subassembly comprising:
an optical unit having a lens and a cavity in communication with the lens;
a base including a body, shaped to fit with in the cavity so as to have a predetermined alignment, and a plurality of leads embedded in and extending from the body, wherein at least one end of one lead is positioned behind the lens when the base is inserted into the cavity; and
an electro-optical component supported by the at least one lead behind the lens when the base is inserted into the optical unit.

2. An electro-optical subassembly, as set forth in claim 1, wherein the base is generally U shaped.

3. An electro-optical subassembly, as set forth in claim 2, wherein arms of the base are inserted into the cavity such that the open portion of the base is closest to the lens.

4. An electro-optical subassembly, as set forth in claim 2, wherein the base is molded using a polymer.

5. An electro-optical subassembly, as set forth in claim 1, wherein the base comprises:
a cross member supporting two arms defining an open area surrounded on at least three sides by the base, wherein the arms of the base are inserted into the cavity such that the open portion of the base is closest to the lens.

6. An electro-optical subassembly, as set forth in claim 1, wherein the optical unit comprises:
an elongated body having a lens formed in one end and a cavity extending through the body to the lens, the elongated body being shaped to interface with an optical port.

7. An electro-optical subassembly, as set forth in claim 1, wherein the cavity is formed to facilitate alignment of the base with the lens.

8. An electro-optical subassembly, as set forth in claim 1, wherein the cavity has at least one flat surface extending at a slight angle to the optical axis of the lens.

9. An electro-optical subassembly, as set forth in claim 6, wherein the elongated body is generally cylinder shaped with at least one flat portion formed thereon.

10. An electro-optical subassembly comprising:
an optical unit having a body with a lens at a first end and a cavity extending from the lens to a second end;
a base having a body supporting a plurality of leads, the body being shaped to fit within the cavity so as to place the leads into a fixed position with respect to the lens; and
an electo-optical component supported by a lead so as to be in optical communication with the lens.

11. An electro-optical subassembly, as set forth in claim 10, wherein the lens of the optical unit is formed as part of the body.

12. An electro-optical subassembly, as set forth in claim 10, wherein walls of the cavity are sloped to facilitate insertion of the base.

13. An electro-optical subassembly, as set forth in claim 10, wherein the body of the base is generally U-shaped.

14. An electro-optical subassembly, as set forth in claim 10, wherein the base is molded over the plurality of leads.

15. An electro-optical subassembly, as set forth in claim 13, wherein one of the plurality of leads is T shaped having first cross member extending between the arms of the U-shaped base and a second cross member extending from the first cross member through the bottom of the U-shaped base.

16. An electro-optical subassembly, as set forth in claim 15, wherein the electro-optical component is a laser supported by the T shaped lead.

17. An electro-optical subassembly, as set forth in claim 16, wherein the laser obtains power from the T shaped lead.

18. An electro-optical subassembly, as set forth in claim 10, wherein a first lead extends between the arms of the U-shaped base and a second lead extends from through the bottom of the U-shaped base toward the first lead.

19. An electro-optical subassembly, as set forth in claim 18, wherein the electro-optical component is a laser supported by the first lead.

20. An electro-optical subassembly, as set forth in claim 19, wherein the laser is wire bonded to and obtains power from the second lead.

21. An electro-optical subassembly, as set forth in claim 19, wherein the first lead is wire bonded to the second lead and the laser obtains power from the first lead via the wire bond.
